(19) United States
(12) Patent Application Publication
(10) Pub. No.: US 2004/0018830 A1
(43) Pub. Date: Jan. 29, 2004

(54) Call reminder

(76) Inventor: Pierluigi Pugliese, Vaterstetten (DE)

Correspondence Address: Docket Administrator, Agere Systems Inc., Room 4U-533C, 4 Connell Drive, Berkeley Heights, NJ, 07922-2747, US

(21) Appl. No.: 10/618,152

(22) Filed: Jul. 11, 2003

(30) Foreign Application Priority Data
Jul. 24, 2002 (DE) 102 33 459.5

(51) Int. Cl. H04M 3/00

(52) U.S. Cl. 455/418; 455/420

(57) ABSTRACT

The invention relates to a reminder functionality in respect to a call that should be established. An object of the invention is to provide a new and improved approach for assisting the user of a phone, especially of a mobile phone in reminding him that a certain number or a certain person should be called. The invention proposes to remind for a certain call which should be established, by activating a reminder functionality for indicating in advance at a phone means, especially a mobile phone, from which said call should be established, that said call should be established.

### CROSS-REFERENCE TO RELATED APPLICATION

This application claims priority of German Patent Application No. 102 33 459.5, which was filed on Jul. 24, 2002

### BACKGROUND OF THE INVENTION

The invention relates to a method and to a system for reminding for a call that should be established as well as to a call reminder and to a software implementation product having such functionality.

As known, very often there is the need to call a telephone number at a certain day and/or at a certain time of a day.

This may be the case for instance, if the person, who should be called, has birthday and the person, who wants to make the call, would like to wish happy birthday. A further situation with regard to a call which should be carried out at a certain time of the day is for example in case a telephone conference between two or more parties is scheduled.

However, there also are situations according to which the person who wants or has to carry out such a call at a certain time is forgetting said call and/or said certain time, for example if he has a lot to do and/or is working outside the office so that nobody can remind him about said call.

Quite a further situation may be, that a required or called person is not available or the respective subscriber's connection is occupied. Thus, if the called party is not answering or even if someone else or an automatic answering machine is answering, usually there is the need to call again the same telephone number and/or the required person after some time.

In particular, if the person, who wants to or has to carry out a call at a certain time owns a mobile phone, currently, some of the above outlined problems can be handled via a so-called re-dial list which is stored in the phone. However, the user of the phone has to look up such re-dial list manually with regard to telephone numbers or required persons to which he wants to or has to make a call.

An object of the invention is therefore to provide a new and improved approach for assisting the user of a phone, especially of a mobile phone in reminding him that a certain number or a certain person should be called.

Accordingly, the invention proposes to activate a reminder means for indicating in advance at a phone means, especially a mobile phone, from which a certain call should be established, that said call should be established.

Thus, in particular by using a system comprising a phone means for establishing a call and means for reminding for a call which is practically realised by the incorporation of a correspondingly designed call reminder hardware and/or software implementation product within such system, the user of such phone means will be significantly assist by reminding the user about calls he has still to make.

To put the inventive approach into practice, it is further proposed that the means for reminding, practically having a clock, is programmable and/or is adapted to automatically activate such reminding indication in regularly time intervals.

It is further proposed, that the system is incorporating a storage associated to the means for reminding, wherein said storage is designed for storing at least one reminding time and/or at least one dial number to which a call should be established from the phone means at a determinable time.

According to preferred embodiments the system is designed as a mobile phone, especially adapted to operate on a GSM-standard and/or on a UMTS-standard.

As a further preferred alternative the phone means for establishing a call is incorporated within a mobile phone and the means for reminding is incorporated within a further electronic device, such as a personal computer or a PDA, which is adapted to communicate with the phone, especially via E-Mail and/or SMS.

Preferably, the reminder means causes the indication of the time at which said call should be established, of the dial number and/or of the name of the required person to which said call should be established. Moreover, it is practically proposed to perform said indication in an optic way for example by displaying the respective indications on a display of the phone means.

Additionally or as an alternative said indication may be performed in an acoustic way, for instance simply by signalling a specific tone or melody or by means of a voice output or announcement. Furthermore, either an indication by means of generating a vibration of the phone is proposed, so that a current conference for example is not disturbed by such reminding functionality.

Provided that a required or called person was not available or the respective subscriber's connection was occupied, it is proposed as a further preferred embodiment to indicate at least the last time according to which a certain call was tried to carried out, so that the user is assist to remind the entire number of tries for calling said required person.

In particular in this regard, the invention is further suggesting, that the reminding means requests the user in response to a failed call attempt, practically be means of an interactive menu procedure, if the said call should be established after a certain time again and/or automatically activates such reminding indication in regularly time intervals in response to a failed call.

Moreover, it is suggested to automatically switch on the phone by the reminding means, when an indication at the phone has to be performed so that a call may be established even if the phone means for establishing was switched off during said reminding functionality.

According to the specific application environment conditions the inventive approach is advantageously implemented with an automatic call establishing functionality which is activated by the reminding means or with an establishing functionality which needs a respective confirmation of the user for example by pressing a corresponding key or by means of a speech control. Preferably these two conditions are selectable according to the respective user behaviour.

### BRIEF DESCRIPTION OF THE DRAWINGS

Subsequently, the invention is exemplary described based on preferred embodiments and with regard to the appending drawings, in which:

FIG. 1 is schematically depicting a flow chart representing preferred embodiments of the inventive approach, and

FIG. 2 is schematically depicting a preferred application of the invention.

### DETAILED DESCRIPTION

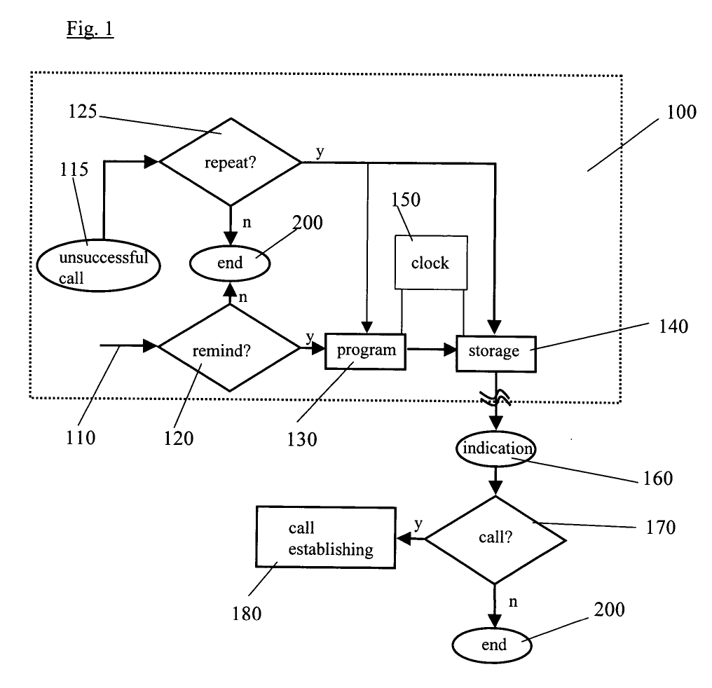

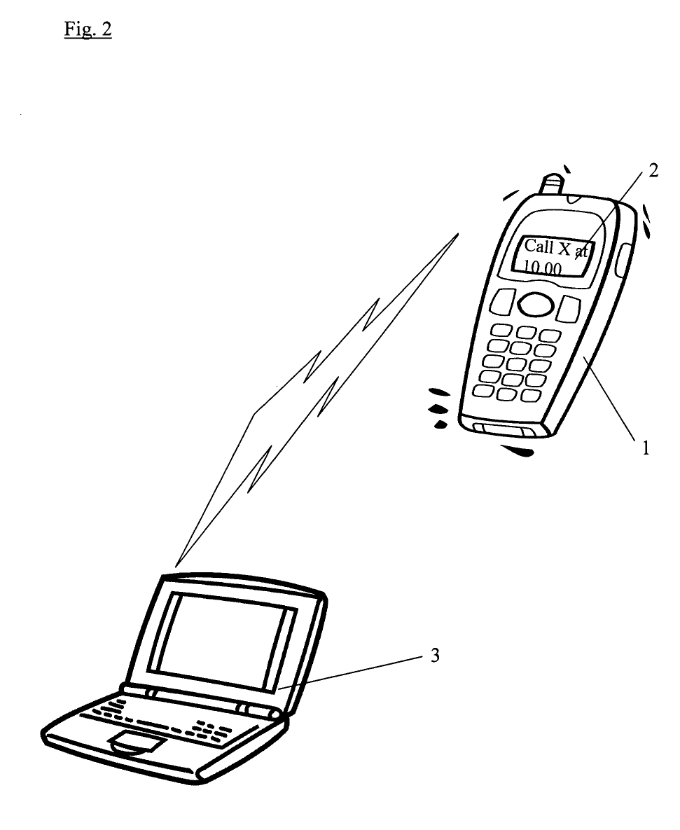

Mainly referring first to FIG. 1 schematically showing a flow chart incorporating preferred embodiments of the inventive approach to assist the user of a phone, especially of a mobile phone 1 (FIG. 2) practically operating on a GSM-standard and/or UMTS-standard, in reminding to call a certain telephone number or a certain person.

According to a first embodiment incorporated by FIG. 1. the user can program in advance at least one time or day he wants to or has to make a certain phone call.

Therefore, based on FIG. 1 the user is selecting a reminding operating menu function 120, such as for example by correspondingly pressing at least one menu key of the mobile phone, as indicated by reference sign 110. It should be mentioned however, that depending on the specific embodiment of the phone, the user also may be able to select the reminding operating menu function 120 by speech control or by using a touch screen display for example.

Preferably the operating menu function 120 within the reminding core functionality 100 comprises an interactive menu so the user can choose in turn if he wants to program a certain phone call or not. Consequently, if the user decided at this time not to program a new reminding function, the reminding core functionality 100 switches to an end condition 200 and is finished until the reminding operating menu function 120 is selected again, for example.

If the user decides however, to program at least one phone call the reminding core functionality 100 is switched by a processor unit and/or by a correspondingly designed software into a program modus for enabling the programming of such a phone call, as indicated by reference sign 130. This is preferably supported by an interactive menu according to which the user can enter a dial number.

In addition or alternatively the user may select the name of the required person who the user wants to call by selecting the name out of a phone book, incorporated in and/or assigned to the mobile phone. Furthermore, the user is preferably entering the time and/or the day according to which the call should be made. If no time and/or the day is entered, the inventive system may be designed to automatically indicate a corresponding reminder in regular time intervals for example, as described below.

The programmed conditions then are stored in a storage 140. The programming means 130 and the storage 140 are practically connected with a clock 150.

Of course, the reminding operating menu may have a further input request step at this point, according to which the user may go back to the interactive operating menu function 120 for programming a further intended call, if he wants to do this.

As a result, when the stored time for an intended call is passed, or even prior to passing the programmed time, such as for example ten minutes before the time is passed, the call reminder means providing the core functionality 100 is activating an indication 160 at the phone for reminding the user that he has to call the programmed dial number.

The indication 160 may be realised in several ways. For example, as indicated in FIG. 2, on the display 2 of the mobile phone 1 a text message may be visualised. Furthermore, the mobile phone may comprise a vibrator means for getting the mobile phone in perceptible vibrations. As a further alternative or in addition an acoustic signal such as a specific tone or a melody may indicate that a call should be made. If the mobile phone 1 has an integrated speech processor, the indication may be also performed by spoken announcement or voice output.

However, regardless of the specific way of indication 160, the user should be at least informed that a call should be made. Preferably the user is additionally informed about the time and about the dial number or the required person he wants to or should call.

Then, according to one specific refinement, in an interactive modus the user is asked by the mobile phone, as indicated by reference sign 170, if he wants to make the call. If the user is then deciding not to make the call, the procedure is going to an end condition 200 for finishing at least for the present this programmed call reminding input. If the user is however deciding to carry out the call, the call is established to the called party, as indicated by reference sign 180, in particular by dialling the respective dial number.

It is mentioned, that the dialling of the intended number may be performed manually, such as for example by pressing a corresponding key sequence using the keyboard of the phone or may be performed automatically by the phone in response to the confirmation of the user that he wants to establish the call.

Preferably the mobile phone reminds the call at the correct time and prompts the user to start the call with the telephone number to call visible indicated 160 on the display 2 and/or the name of the required person, if stored in advance during the programming step 130 or if the required person is present within the phone bock associated with the phone 1 and allocated to said telephone number, so that the user is preferably able to carry out the call simply by confirming 170 with merely one key press.

However, dependent on the specific embodiment of the phone, the entire dialling and call establishing procedure may be performed automatically by the mobile phone, especially by the correspondingly adapted processor or by the correspondingly adapted software implemented within the phone 1, especially within a SIM-card of the mobile phone, immediate and punctual for the stored time without asking for confirmation 170 by performing the necessary steps for establishing the programmed call practically subsequent to the indication 160 at the mobile phone.

Moreover, according to very preferred embodiments and in case the mobile phone 1 was switched off, the mobile phone 1 is automatically switched on at the programmed calling time, i.e. when the call should be reminded, and is activating the indication 160 displaying the telephone number and/or the name of the person to call for reminding for said call. If then the user wants to start the call but has to validate the PIN (Personal Identification Number) first, the user is further asked to enter the PIN before starting the call.

If the mobile phone 1 does not support an automatic power-on based on the clock 150 or programmed time then the reminding indication 160 for a certain call is practically activated immediately when the mobile phone 1 is manually set from a power-off condition into the power-on condition.

According to a further preferred embodiment the mobile phone 1 is asked at the end of a call 115 if the user wants to retry the call after a certain time, as indicated by reference sign 125. Even, the request 125 for a repeated try may be supported in an application specific service matter, such as in response to each finished call 115 and/or caused by an unsuccessful call, for example when there was merely an answering machine or no answer from the called party. As well a call fraught with problems, if for example the respective subscriber's connection was occupied and/or the link to the called party could not have been established, may cause an activation of the component supporting such call re-try functionality. If the user wants to retry said call, he in turn programs 130 for example the time at which he wants to retry the call. On the other hand side a regularly time interval may be pre-implemented or selected by the user according to which the next indication 160 for reminding the user is activated.

The dial number of the preceded call attempt 115 together with the programmed time or the time according to the specific regularly time interval is then stored 150 for the respective next activation of the call reminder indication 160.

In particular in the case the mobile phone is asking the user for a call repeating, the first and/or the last time according to which the reminded call tried may be additionally indicated and hence, can appear for example on the display 2, too.

As can be further seen from FIG. 2 even the separation of the components and/or procedures for performing the inventive call reminder functionality, as discussed above, is possible.

For instance, the call reminding core functionality 100 according to FIG. 1, in particular the programming and storage functionality 130 and 140 may be integrated or implemented within a personal computer or a note book 3 which is adapted to communicate with the mobile phone 1, for especially via E-Mail and/or SMS (Short Message Service).

Accordingly, when the programmed time is reached based on an integrated clock of the note book 3, the note book 3 is adapted to establish link to the mobile phone 1 for sending for example a text message, corresponding to the indication 160 of FIG. 1, that is visualised at the display 2 of the mobile phone 1. Based thereon, one of the afore described confirm and/or dial procedure are activated.

As a consequence, using the correspondingly adapted inventive approach based on such a separation of operation functions, even a further person may be entitled to input certain call reminders for the indication at the exemplar mobile phone 1, for example by an organiser implemented within the note book 3. Then the person using the mobile phone 1 may be advised accordingly by sending a call reminder message from the note book 3 to the mobile phone 1.

What is claimed:

1. A method of reminding for a certain call which should be established, comprising the step of activating a reminder functionality for indicating in advance at a mobile phone, from which said call should be established, that said call should be established.

2. A method of claim 1, wherein the step of activating is based on a programmable time and/or is automatically activated in regularly time intervals.

3. A method of claim 1, wherein the step of indicating comprises the indication of the time at which said call should be established, and are of the subscriber number and the subscriber name to which said call should be established.

4. A method of claim 1, wherein the step of indication is performed in at least one of an optic and/or acoustic way and/or by means of vibrations.

5. A method of claim 1, further characterized in that the call reminder is activated by a remote device designed to communicate with said phone at least a moment prior to or at the time at which said call should be established, especially by means of E-mail and/or SMS.

6. A method of claim 1, further characterized in that at least the last time according to which it was tried to carry out a certain call is indicated.

7. A method of 1, further characterized by requesting the user in response to an unsuccessful call attempt, in particular be means of an interactive menu procedure, if said call should be established after a certain time again.

8. A method of claim 1, wherein the phone (1) is switched on in response to an activation of said call reminding functionality.

9. A method of claim 1, wherein the step of establishing said certain call is automatically activated in response to at least one of the step of indicating confirmation by the user.

10. A system, comprising:
means for establishing a call, and
means for reminding a user to establish the call.

11. A system of claim 10, wherein the means for reminding is programmable, and adapted to automatically activate the means for indication in regular time intervals.

12. A system of claim 10, characterized by a storage associated to the means for reminding, wherein the storage is designed for storing at least one of a reminding time and at least one subscriber number to which a call has to be generated at a determinable time.

13. A system of any of claim 10, characterized in that said system is incorporated within a mobile phone adapted to operate on at least one of a GSM-standard and/or a UMTS-standard.

14. A system of any of claim 10, wherein the means for establishing a call is incorporated within a mobile phone, and the means for reminding at least is partially incorporated within a further electronic device, adapted to communicate with the mobile phone, especially, via E-Mail and/or SMS.

15. A system of claim 10, wherein the means for indication adapted to indicate at least one of the time at which said call should be established, the subscriber number and the subscriber name to which said call should be established.

16. A system of claim 10, wherein the means for indication reminding comprises a display, an acoustic indication means designed for signalling a specific tone or melody or voice output and an indication means adapted to generate a vibration of the phone means.

17. A system of claim 10, wherein the reminding means is adapted to request the user in response to a failed call attempt, if the said call should be established after a certain time again.

18. A system of claim 10, wherein the means for reminding is switching on the means for establishing in case the means for establishing is switched off during a reminding condition.

19. A system of claim 10, adapted to indicate at least the last time according to which a certain call was tried to be established.

20. A system of claims 10, wherein the means for reminding is designed to remind in regularly time intervals in response to a call which could not be established.

21. A system of any of claims 10, wherein the phone means for establishing a call is automatically activated by the reminding means.
